(19) United States
(12) Patent Application Publication
(10) Pub. No.: US 2026/0117958 A1
(43) Pub. Date: Apr. 30, 2026

(54) Snap-fit installation and removal structure for ceiling lamp and ceiling lamp

(71) Applicant: DONGGUAN JIASHENG LIGHTING TECHNOLOGY CO., LTD., Dongguan City (CN)

(72) Inventor: Chih-pin HSU, Dongguan City (CN)

(73) Assignee: DONGGUAN JIASHENG LIGHTING TECHNOLOGY CO., LTD., Dongguan City (CN)

(21) Appl. No.: 19/383,449

(22) Filed: Nov. 7, 2025

(30) Foreign Application Priority Data
Sep. 28, 2025 (CN) 202522090116.5

(51) Int. Cl. F21V 21/03; F21S 8/04

(52) U.S. Cl. CPC F21V 21/03; F21S 8/04

(57) ABSTRACT

A snap-fit installation and removal structure for a ceiling lamp and a ceiling lamp are provided. The ceiling lamp is connected to a mounting surface through the snap-fit installation and removal structure, which includes a mounting member and a ceiling lamp body. The ceiling lamp body includes a first end and a second end disposed at opposite ends of the ceiling lamp body. The mounting member includes a first end and a second end disposed at opposite ends of the mounting member. The first end of the mounting member is snap-fitted with the first end of the ceiling lamp body, and the second end of the mounting member is elastically snap-fitted with the second end of the ceiling lamp body. A first state and a second state exist between the second end of the mounting member and the second end of the ceiling lamp body.

### TECHNICAL FIELD

The present disclosure relates to the technical field of ceiling lamps, and in particular to a snap-fit installation and removal structure for a ceiling lamp and a ceiling lamp.

### BACKGROUND

CN107166269A discloses a replaceable quick-mount ceiling lamp. To install a mounting bracket, it is necessary to first remove and install the fasteners, and then remove and install the mounting bracket, resulting in complicated installation and removal steps.

Therefore, the prior art needs to be improved.

### SUMMARY

In view of the deficiencies in the prior art, the present disclosure provides a snap-fit installation and removal structure for a ceiling lamp and a ceiling lamp, which is intended to solve the technical problems in related technology where before installing a mounting bracket for a ceiling lamp, it is necessary to first remove and install the fasteners and then remove and install the mounting bracket, resulting in complicated installation and removal steps.

Technical solutions of the present disclosure for solving the above technical problems are as follows:

the present disclosure provides a snap-fit installation and removal structure for a ceiling lamp, where the ceiling lamp is connected to a mounting surface through the snap-fit installation and removal structure, and the snap-fit installation and removal structure includes:

a ceiling lamp body, including a first end of the ceiling lamp body and a second end of the ceiling lamp body disposed at opposite ends of the ceiling lamp body;

a mounting member, including a first end of the mounting member and a second end of the mounting member disposed at opposite ends of the mounting member, where the first end of the mounting member is snap-fitted with the first end of the ceiling lamp body, and the second end of the mounting member is elastically snap-fitted with the second end of the ceiling lamp body;

a first state and a second state exist between the second end of the mounting member and the second end of the ceiling lamp body;

in the first state, the second end of the mounting member is in sliding contact with the second end of the ceiling lamp body, enabling the mounting member to be disengaged from the ceiling lamp body; and

in the second state, the second end of the mounting member is in snap-fitted engagement with the second end of the ceiling lamp body, enabling the mounting member to be in snap-fitted engagement with the ceiling lamp body.

In some embodiments, the second end of the ceiling lamp body is provided with a button, and the button is movable between a first position corresponding to the second state and a second position corresponding to the first state.

In some embodiments, an end of the button near the second end of the mounting member abuts against a first elastic member, and an end of the first elastic member away from the button abuts against the second end of the ceiling lamp body.

In some embodiments, the second end of the mounting member is provided with an elastic contact portion, and a side of the elastic contact portion near the button is in contact with the button.

In some embodiments, a side of the elastic contact portion away from the button abuts against a second elastic member, and an end of the second elastic member away from the elastic contact portion abuts against the second end of the mounting member.

In some embodiments, the second end of the ceiling lamp body is provided with a recess, the second end of the mounting member is provided with a lug, and the lug is in snap-fitted engagement with the recess.

In some embodiments, at least a portion of the lug forms an L-shaped lug, the recess is provided with a limiting portion, the limiting portion abuts against the L-shaped lug to limit a position of the L-shaped lug.

In some embodiments, the first end of the ceiling lamp body is provided with a slot, the first end of the mounting member is provided with a snap-fit protrusion, and the snap-fit protrusion is in snap-fitted engagement with the slot.

In some embodiments, the first end of the ceiling lamp body is provided with a first guide flange, and the first guide flange is configured to provide positioning for a connection between the first end of the mounting member and the first end of the ceiling lamp body; and/or

the second end of the ceiling lamp body is provided with a second guide flange, and the second guide flange is configured to provide positioning for a connection between the second end of the mounting member and the second end of the ceiling lamp body.

The present disclosure further provides a ceiling lamp, including:

the snap-fit installation and removal structure for a ceiling lamp as described above; and

a connecting member connected to the mounting member and configured to connect the ceiling lamp to the mounting surface.

Beneficial effects: In the present disclosure, one end of the mounting member is snap-fitted with one end of the ceiling lamp body, the other end of the mounting member and the other end of the ceiling lamp body are configured with a first state (sliding contact) corresponding to removal and disengagement, and a second state (snap-fit engagement) corresponding to installation and engagement, such that the other end of the mounting member and the other end of the ceiling lamp body can be engaged with each other and disengaged from each other simply by applying external force to switch them from the second state to the first state, without the need for an additional electromagnetic device. The structure is simplified and the cost is reduced. Therefore, the snap-fit installation and removal structure for a ceiling lamp provided in the present disclosure solves the problems in related technology where before installing a mounting bracket for a ceiling lamp, it is necessary to first remove and install the fasteners and then remove and install the mounting bracket, resulting in complicated installation and removal steps.

### BRIEF DESCRIPTION OF THE DRAWINGS

In order to more clearly illustrate the technical solutions of the embodiments of the present disclosure, the accompanying drawings used in the description of the embodiments are briefly introduced below. Obviously, the accompanying drawings described below illustrate only some embodiments of the present disclosure, and that other drawings may be derived by those of ordinary skill in the art without inventive effort.

FIG. 1 is an exploded schematic structural diagram of a snap-fit installation and removal structure for a ceiling lamp according to some embodiments of the present disclosure.

FIG. 2 is a schematic diagram of a perspective view of a ceiling lamp body of a snap-fit installation and removal structure according to some embodiments of the present disclosure.

FIG. 3 is a schematic perspective view of a mounting member of a snap-fit installation and removal structure according to some embodiments of the present disclosure.

FIG. 4 is a schematic structural diagram of a partial sectional view of a mounting member and a ceiling lamp body of the snap-fit installation and removal structure according to some embodiments of the present disclosure, where a button is located in a first position.

FIG. 5 is a schematic diagram of a perspective view of a snap-fit installation and removal structure, without a ceiling lamp body, according to some embodiments of the present disclosure.

FIG. 6 is a schematic diagram of a partial plan view of a snap-fit installation and removal structure, without a ceiling lamp body, according to some embodiments of the present disclosure.

Reference numerals in the accompanying drawings: 100. ceiling lamp body; 110. first end of ceiling lamp body; 120. second end of ceiling lamp body; 121. through hole; 122. recess; 200. mounting member; 210. first end of mounting member; 220. second end of mounting member; 221. lug; 222. elastic contact portion; 500. button; 31. receiving groove; 51. first guide flange; 52. second guide flange; 61. slot; 62. snap-fit protrusion; 81. L-shaped lug; 82. limiting portion; 91. first elastic member; and 92. second elastic member.

### DETAILED DESCRIPTIONS OF THE EMBODIMENTS

It can be understood by those skilled in the art that singular forms “aforesaid”, “aforementioned”, “said” and “the” used herein may also include plural forms unless expressly stated. It should be further understood that the word “comprise/include” used in the description of the present disclosure means presence of stated features, integers, steps, operations, elements and/or modules, but does not exclude the presence or addition of one or more other features, integers, steps, operations, elements, modules and/or groups thereof. It should be understood that when an element is referred to as being “connected” or “coupled” to another element, it may be directly connected or coupled to another element, or intervening elements may also be present. In addition, “connected” or “coupled” as used herein may also include wireless connections or wireless couplings. As used herein, the term “and/or” includes any one or all of unit and all combinations of one or more of the associated listed items.

It should be understood by those skilled in the art that unless otherwise defined, all terms (including technical terms and scientific terms) used herein have the same meanings as those generally understood by those skilled in the art to which the present disclosure belongs. It should also be understood that terms such as those defined in a general dictionary should be understood to have meanings consistent with those in the context of the prior art and will not be interpreted in idealized or overly formal meanings unless specifically defined herein.

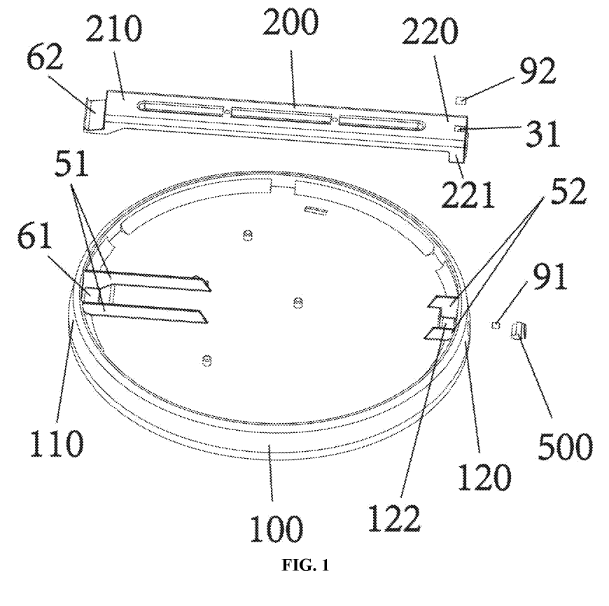

Referring to FIGS. 1, 2, and 3, the present disclosure provides a snap-fit installation and removal structure for a ceiling lamp. The ceiling lamp having the snap-fit installation and removal structure can be secured to a mounting surface (for example, a ceiling) via the snap-fit installation and removal structure. The snap-fit installation and removal structure includes a ceiling lamp body 100 and a mounting member 200 that are detachably connected from bottom to top. The ceiling lamp body 100 may be, but is not limited to, a disc shaped structure, including a first end 110 of the ceiling lamp body and a second end 120 of the ceiling lamp body disposed at opposite ends of the ceiling lamp body. The mounting member 200 may be, but is not limited to, a bar shaped bracket structure, including a first end 210 of the mounting member and a second end 220 of the mounting member disposed at opposite ends of the mounting member.

The first end 210 of the mounting member is snap-fitted with the first end 110 of the ceiling lamp body. In some embodiments, the first end 110 of the ceiling lamp body is provided with a slot 61, the first end 210 of the mounting member is provided with a snap-fit protrusion 62, and the snap-fit protrusion 62 is inserted into the slot 61 and is in snap-fitted engagement with the slot 61, such that the first end 210 of the mounting member is snap-fitted with the first end 110 of the ceiling lamp body. In some implementation modes of this embodiment, an outer surface of the first end 110 of the ceiling lamp body is fixedly provided (for example, integrally formed) with a first guide flange 51 surrounding the slot 61. The first guide flange 51 is configured to provide positioning for the snap-fit engagement between the snap-fit protrusion 62 and the slot 61.

The second end 220 of the mounting member is elastically snap-fitted with the second end 120 of the ceiling lamp body. A first state and a second state exist between the second end 220 of the mounting member and the second end 120 of the ceiling lamp body. In the first state, the second end 220 of the mounting member is in sliding contact with the second end 120 of the ceiling lamp body, in which case, the second end 220 of the mounting member and the second end 120 of the ceiling lamp body only contact each other but are not fixed, thereby allowing them to be separated. In the second state, the second end 220 of the mounting member is in snap-fitted engagement with the second end 120 of the ceiling lamp body, in which case, combined with the snap-fit engagement between the first end 210 of the mounting member and the first end 110 of the ceiling lamp body, the ceiling lamp body 100 and the mounting member 200 are secured together.

In the snap-fit installation and removal structure for a ceiling lamp provided in the present disclosure, one end of the mounting member is snap-fitted with one end of the ceiling lamp body, the other end of the mounting member and the other end of the ceiling lamp body are configured with a first state (sliding contact) corresponding to removal and disengagement, and a second state (snap-fit engagement) corresponding to installation and engagement, such that the other end of the mounting member and the other end of the ceiling lamp body can be engaged with each other and disengaged from each other simply by applying external force to switch them from the second state to the first state, thereby achieving quick installation and removal, with a simple structure and reduced cost. Therefore, the snap-fit installation and removal structure for a ceiling lamp provided in the present disclosure solves the problems in related technology where before installing a mounting bracket for a ceiling lamp, it is necessary to first remove and install the fasteners and then remove and install the mounting bracket, resulting in complicated installation and removal steps.

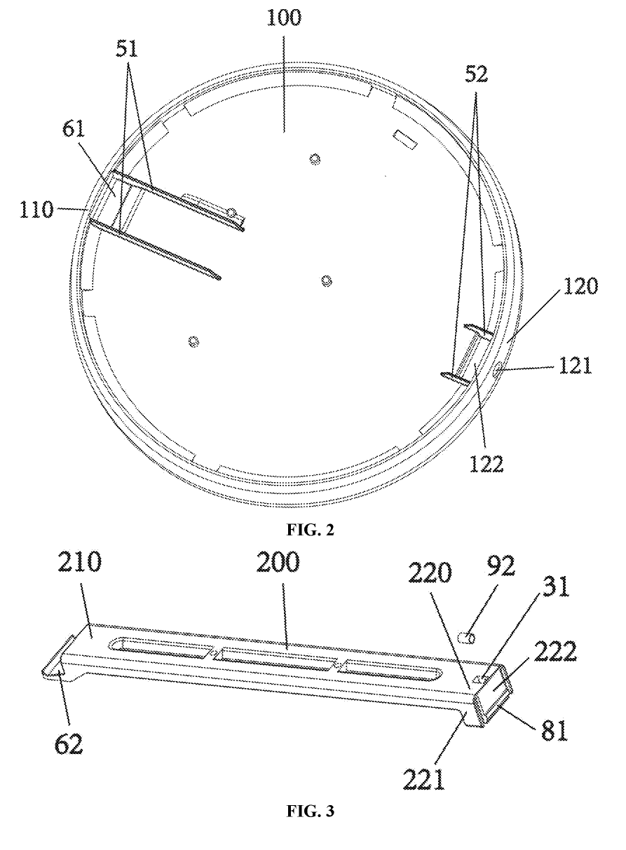

Further, as shown in FIGS. 1 and 2, the second end 120 of the ceiling lamp body is provided with a button 500. The button 500 is movable between a first position and a second position. In some embodiments, the second end 120 of the ceiling lamp body is provided with a through hole 121, and the button 500 is located inside the through hole 121. One end face of the button 500 is exposed outside the second end 120 of the ceiling lamp body, and an opposite end of the button 500 is located inside the second end 120 of the ceiling lamp body and is configured to prevent the button 500 from disengaging from the second end 120 of the ceiling lamp body via the through hole 121. The opposite end of the button 500 abuts against one end of a first elastic member 91 (for example, a spring), and an opposite end of the first elastic member 91 abuts against and is engaged with an inner wall of the second end 120 of the ceiling lamp body. When no external force is applied, elastic force of the first elastic member keeps the button 500 fixed within the through hole 121, in which case, the button 500 is located in a first position. When external force is applied (for example, a user presses the aforementioned end face), the first elastic member 91 is compressed, allowing the button 500 to move toward the second end 120 of the ceiling lamp body in an axis direction of the through hole 121. When the first elastic member 91 is compressed to a certain extent, the button 500 is driven to reach the second position. The first position corresponds to the aforementioned second state meaning that, in which case, the second end 220 of the mounting member is in snap-fitted engagement with the second end 120 of the ceiling lamp body, combined with the snap-fit engagement between the first end 210 of the mounting member and the first end 110 of the ceiling lamp body, the ceiling lamp body 100 and the mounting member 200 are secured together. The second position corresponds to the aforementioned first state, meaning that, in which case, the second end 220 of the mounting member is in sliding contact with the second end 120 of the ceiling lamp body, the second end 220 of the mounting member and the second end 120 of the ceiling lamp body only contact each other but are not fixed, thereby allowing them to be separated.

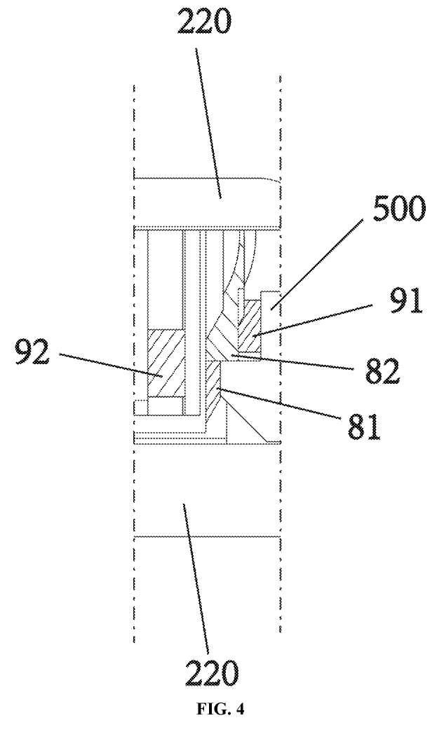

Further, as shown in FIGS. 2 and 4, the second end 120 of the ceiling lamp body is provided with a recess 122, and the second end 220 of the mounting member is provided (for example, integrally formed) with a lug 221. The lug 221 is inserted into the recess 122 and is in snap-fitted engagement with the recess 122 to prevent the lug 221 from disengaging from the recess 122 in the second state. In some embodiments, at least a portion of the lug 221 forms an L-shaped lug 81, and the recess 122 is fixedly provided (for example, integrally formed) with a limiting portion 82. The L-shaped lug 81 abuts against the limiting portion 82 to prevent the lug 221 from disengaging from the recess 122 in the second state. In other words, as shown in FIG. 4, a short side of the L-shaped lug 81 (upright “L”) abuts against a bottom surface of the limiting portion 82, such that the limiting portion 82 prevents the lug 221 from actively disengaging from the recess 122 through an opening of the recess 122. In some embodiments, an outer surface of the second end 120 of the ceiling lamp body is fixedly provided (for example, integrally formed) with a second guide flange 52 surrounding the recess 122. The second guide flange 52 is configured to provide positioning for the snap-fit engagement between the lug 221 and the recess 122.

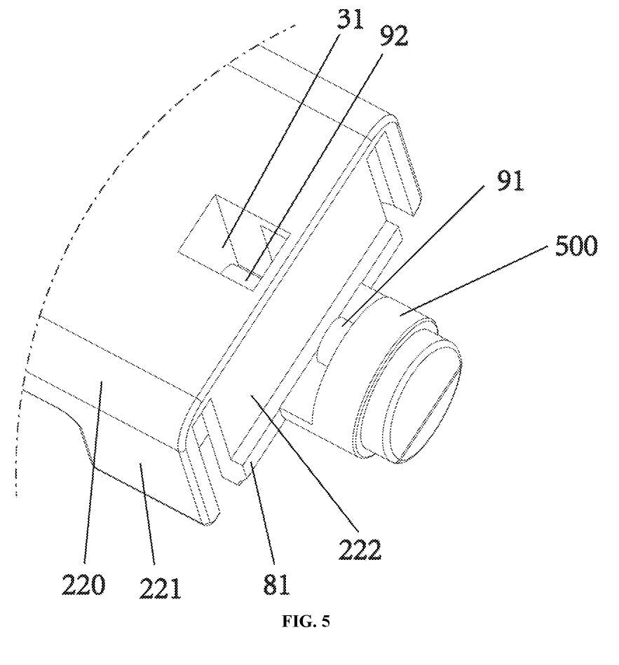

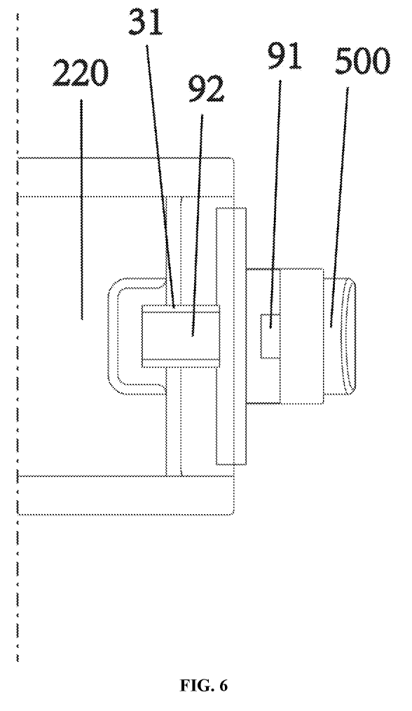

Further, as shown in FIGS. 5 and 6, the second end 220 of the mounting member is provided with an elastic contact portion 222. The elastic contact portion 222 may be a part of the lug 221, and the L-shaped lug 81 may also form a part of the elastic contact portion 222. When the button 500 moves from the first position to the second position, a side surface of the elastic contact portion 222 near the button 500 maintains contact with the button 500. In some embodiments, a side surface of the elastic contact portion 222 away from the button 500 abuts against one end of a second elastic member 92 (for example, a spring). The second elastic member 92 is disposed in a receiving groove 31 formed in the second end 220 of the mounting member, and the other end of the second elastic member 92 away from the elastic contact portion 222 abuts against and is engaged with an inner wall of the receiving groove 31. Elastic force of the second elastic member 92 ensures that the elastic contact portion 222 maintains sliding contact with the button 500 during movement of the button 500 from the first position to the second position.

When the ceiling lamp needs to be installed on a mounting surface, the user first fixes the mounting member to the mounting surface using additional fasteners. Then, by aligning the first end of the ceiling lamp body with the first end of the mounting member, the snap-fit protrusion is snap-fitted into the slot along the first guide flange; and finally, by aligning the second end of the ceiling lamp body with the second end of the mounting member, the lug is snap-fitted into the recess along the second guide flange. Elastic force of the first elastic member and the second elastic member located on both sides of the elastic contact portion ensures that the elastic contact portion tightly abuts against an inner wall of the recess, and the limiting portion of the recess restricts the elastic contact portion from actively disengaging from the recess, thereby securing the ceiling lamp body to the mounting member and completing the installation of the ceiling lamp onto the mounting surface. The installation steps are simple and allow for rapid installation. In addition, an installation wire (not shown in the figures, for example, a power cord) of the ceiling lamp body passes through a through hole in the mounting member and is then disposed in an additional connecting member (not shown in the figures, e.g., a junction box), thereby enabling a connection to additional wiring or interfaces.

When the ceiling lamp needs to be removed from the mounting surface, the user presses the button. The first elastic member is compressed by the external force, and the button moves from the first position to the second position, and exerts pressure on the elastic contact portion. The elastic contact portion is compressed and in turn presses against the second elastic member. The compression of the first elastic member and the second elastic member ensures sliding contact between the elastic contact portion and the button. The L-shaped lug of the elastic contact portion is disengaged from the limiting portion of the recess. When the button is moved to the second position, the user can remove the elastic contact portion from the recess, thereby disassembling the ceiling lamp body from the mounting member. The removal steps are simple and allow for rapid removal.

Based on the snap-fit installation and removal structure for a ceiling lamp provided in the present disclosure, the present disclosure further provides a ceiling lamp, which includes the aforementioned snap-fit installation and removal structure for a ceiling lamp provided in the present disclosure (not shown in the figures). The connecting member is engaged with the mounting member of the snap-fit installation and removal structure, and is configured to connect the ceiling lamp to the mounting surface, thereby enabling the ceiling lamp and the snap-fit installation and removal structure to be installed and removed quickly and easily.

In summary, the present disclosure provides a snap-fit installation and removal structure for a ceiling lamp. The ceiling lamp is connected to a mounting surface through the snap-fit installation and removal structure, which includes a mounting member and a ceiling lamp body. The ceiling lamp body includes a first end and a second end disposed at opposite ends of the ceiling lamp body. The mounting member includes a first end and a second end disposed at opposite ends of the mounting member. The first end of the mounting member is snap-fitted with the first end of the ceiling lamp body, and the second end of the mounting member is elastically snap-fitted with the second end of the ceiling lamp body. A first state and a second state exist between the second end of the mounting member and the second end of the ceiling lamp body; the second end of the mounting member is in sliding contact with the second end of the ceiling lamp body, allowing the mounting member to be disengaged from the ceiling lamp body; and the second end of the mounting member is in snap-fitted engagement with the second end of the ceiling lamp body, allowing the mounting member to be in snap-fitted engagement with the ceiling lamp body. In the present disclosure, one end of the mounting member is snap-fitted with one end of the ceiling lamp body, the other end of the mounting member and the other end of the ceiling lamp body are configured with a first state (sliding contact) corresponding to removal and disengagement, and a second state (snap-fit engagement) corresponding to installation and engagement, such that the other end of the mounting member and the other end of the ceiling lamp body can be engaged with each other and disengaged from each other simply by applying external force to switch them from the second state to the first state, thereby achieving quick installation and removal, with a simple structure and reduced cost.

In the present disclosure, it should be understood that orientation or position relationships indicated by the terms “length”, “width”, “height”, “upper”, “lower”, “front”, “rear”, “left”, “right”, “vertical”, “horizontal”, “top”, “side”, “bottom”, “interior”, “exterior” and the like, are based on orientation or position relationships shown in the drawings, merely for the convenience of describing the present disclosure and simplifying the description, instead of indicating or implying that the indicated device or element must have particular orientations or be constructed and operated in particular orientations. Therefore, these terms cannot be construed as a limitation to the present disclosure.

It should be understood that the terms “first” and “second” are only used for descriptive purposes, and should not be construed as indicating or implying relative importance or implicitly indicating the number of technical features. Thus, features defined by “first” and “second” may explicitly or implicitly include one or more of the features. In the description of the embodiments of the present disclosure, “plurality” means two or more, unless expressly specified otherwise.

It should be understood that, unless otherwise explicitly specified and defined, the terms “mounting”, “connecting”, “connection”, “fixing”, etc. herein should be understood in a broad sense, for example, they may be a fixed connection, a detachable connection, or an integrated connection; may be a mechanical connection, or an electrical connection; may be a direct connection, or an indirect connection via an intermediate medium; and may be communication inside two elements, or an interactive relation between two elements. For those of ordinary skill in the art, specific meanings of the above terms in the embodiments of the present disclosure could be understood according to specific circumstances.

The above embodiments are intended only to illustrate the present disclosure and are not intended to limit the scope of the present disclosure. Any modifications or variations that do not depart from the spirit shall fall within the scope of protection of the present disclosure.

What is claimed is:

1. A snap-fit installation and removal structure for a ceiling lamp, and the ceiling lamp is connected to a mounting surface through the snap-fit installation and removal structure, wherein the snap-fit installation and removal structure comprises:
a ceiling lamp body, comprising a first end of the ceiling lamp body and a second end of the ceiling lamp body disposed at opposite ends of the ceiling lamp body;
a mounting member, comprising a first end of the mounting member and a second end of the mounting member disposed at opposite ends of the mounting member, wherein the first end of the mounting member is snap-fitted with the first end of the ceiling lamp body, and the second end of the mounting member is elastically snap-fitted with the second end of the ceiling lamp body;
a first state and a second state exist between the second end of the mounting member and the second end of the ceiling lamp body;
in the first state, the second end of the mounting member is in sliding contact with the second end of the ceiling lamp body, enabling the mounting member to be disengaged from the ceiling lamp body; and
in the second state, the second end of the mounting member is in snap-fitted engagement with the second end of the ceiling lamp body, enabling the mounting member to be in snap-fitted engagement with the ceiling lamp body.

2. The snap-fit installation and removal structure for a ceiling lamp according to claim 1, wherein the second end of the ceiling lamp body is provided with a button, and the button is movable between a first position corresponding to the second state and a second position corresponding to the first state.

3. The snap-fit installation and removal structure for a ceiling lamp according to claim 2, wherein an end of the button near the second end of the mounting member abuts against a first elastic member, and an end of the first elastic member away from the button abuts against the second end of the ceiling lamp body.

4. The snap-fit installation and removal structure for a ceiling lamp according to claim 3, wherein the second end of the mounting member is provided with an elastic contact portion, and a side of the elastic contact portion near the button is in contact with the button.

5. The snap-fit installation and removal structure for a ceiling lamp according to claim 4, wherein a side of the elastic contact portion away from the button abuts against a second elastic member, and an end of the second elastic member away from the elastic contact portion abuts against the second end of the mounting member.

6. The snap-fit installation and removal structure for a ceiling lamp according to claim 1, wherein the second end of the ceiling lamp body is provided with a recess, the second end of the mounting member is provided with a lug, and the lug is in snap-fitted engagement with the recess.

7. The snap-fit installation and removal structure for a ceiling lamp according to claim 6, wherein at least a portion of the lug forms an L-shaped lug, the recess is provided with a limiting portion, the limiting portion abuts against the L-shaped lug to limit a position of the L-shaped lug.

8. The snap-fit installation and removal structure for a ceiling lamp according to claim 1, wherein the first end of the ceiling lamp body is provided with a slot, the first end of the mounting member is provided with a snap-fit protrusion, and the snap-fit protrusion is in snap-fitted engagement with the slot.

9. The snap-fit installation and removal structure for a ceiling lamp according to claim 1, wherein the first end of the ceiling lamp body is provided with a first guide flange, and the first guide flange is configured to provide positioning for a connection between the first end of the mounting member and the first end of the ceiling lamp body; and/or
the second end of the ceiling lamp body is provided with a second guide flange, and the second guide flange is configured to provide positioning for a connection between the second end of the mounting member and the second end of the ceiling lamp body.

10. A ceiling lamp, comprising:
the snap-fit installation and removal structure for a ceiling lamp according to claim 1, and
a connecting member, connected to the mounting member and configured to connect the ceiling lamp to the mounting surface.
